(19) United States
(12) Patent Application Publication
(10) Pub. No.: US 2003/0040410 A1
(43) Pub. Date: Feb. 27, 2003

(54) Method and device for a packaging machine

(75) Inventor: Jaako Haggman, Helsinki (FI)

Correspondence Address: FITCH EVEN TABIN AND FLANNERY, 120 SOUTH LA SALLE STREET, SUITE 1600, CHICAGO, IL, 60603-3406, US

(73) Assignee: UPM-Kymmene Corporation

(21) Appl. No.: 10/272,276

(22) Filed: Oct. 16, 2002

Related U.S. Application Data
(63) Continuation of application No. 09/716,633, filed on Nov. 20, 2000.
Application No. 09/716,633 is a continuation of application No. PCT/FI99/00404, filed on May 12, 1999.

(30) Foreign Application Priority Data
May 29, 1998 (FI) 98112 23

(51) Int. Cl. B31B 1/74

(52) U.S. Cl. 493/155

(57) ABSTRACT

The object of the invention is a method for a packaging machine, in the container-forming unit of which the casing is formed to be substantially ready, whereby the sidewall blank (O) of the casing is placed on at least one mandrel or the like, preferably on the outer surface (2a) of a wrapping mandrel in the container-forming unit. The first end member (P) of the casing is placed on the end face of the mandrel, and the end member is joined to the bottom portion of the sidewall blank. The casing formed on the mandrel is removed from the mandrel to be advanced to the next process stage to be carried out in the packaging machine. In order to remove the casing (OP) from the mandrel (2), axial transfer energy is directed towards the inner surface of the end member (P) of the casing (OP). To facilitate the removal, the contact between the iner surface of the sidewall blank (O) and the outer surface (2a) of the mandrel (2) is released in radial direction. It is possible to utilise a gaseous pressure medium brought from the inside of the mandrel (2) to generate the axial transfer energy and to release the contact in radial direction.

The object of the invention is a method for a packaging machine, in whose container-forming unit in which the casing is formed so as to be substantially ready, whereby the sidewall blank of the casing is placed on at least one mandrel or the like, preferably on the side surface of a wrapping mandrel, and the first end member of the casing is placed on the face of the mandrel and this end member is joined to the end of the sidewall blank, after which the casing which was formed on the mandrel is removed from it to be taken on to the next process stage to be carried out in the package machine.

It is known in the prior art to form cylindrical packages out of liquid packaging board, the said packages consisting of a cylindrical sidewall blank, which has preferably been placed in an upright position and which has been formed by bonding together the vertical edges of the heat-seal coated blank, and of end members that seal the sidewall blank from above and below, the upper one of which has an openable aperture which has been closed e.g. with a closure cap or strip. Such packages are used to pack different kinds of beverages in a sterile and airtight manner. Packages in which the end member forms an entirely detachable cap are also known, and such packages can be used for packaging solid foods, such as ice cream.

The package, into which the stored material such as a beverage is fed later in the process, is automatically formed in the container-forming unit, which has a series of so-called wrapping mandrels around which the sidewall blank is formed by wrapping. The wrapping mandrels are arranged in a rotating structure which moves the mandrels between the different handling units, where one particular operation is carried out at a time, and in this way a can-shaped casing is gradually formed and in the final handling unit from the mandrel, after which the casing is conveyed to the filling unit to be filled and closed.

A known packaging machine that comprises a container-forming unit and a filling unit is presented e.g. in a European patent EP-456011. Even though this publication does not specifically describe the removal of the can from the mandrel, this happens in practice by drawing the can from the mandrel with a mechanical member.

Especially in fast working packaging machines, problems have arisen as to how to remove the casing formed on the mandrel reliably, especially those casings formed on a wrapping mandrel. U.S. Pat. Nos. 4,318,703, 4,100,842 and 4,490,130 have described how an axial transmission effect is exerted on the inner surface of the end member of the casing by a gaseous transmission medium such as compressed air.

Especially casings in the form of a truncated cone can be easily removed by an axial impulse. Problems can, however, arise with cylindrical casings, which may be tightly wrapped around the mandrel.

In fast-working packaging machines, the sidewall blank is normally wrapped around the mandrel, in which case the inner surface of the sidewall blank may cling to the side surface of the wrapping mandrel, thus producing friction which is not easily controlled between the said surfaces in a continuous process. This frictional force is a process variable that is difficult to control and it may disturb the functioning of the container-forming unit and thus the whole process.

The purpose of this invention is to present a method which makes it possible to ensure, as far as possible, that all shapes of casings can be released from the mandrel in a controlled and precise manner, and to ensure that the process variables that possibly applied in the previous process stages will not have a detrimental effect on the process variables used at the release stage.

To carry out these objectives it is mainly characteristic of the method relating to the invention that the removal of the casing from the mandrel is carried out by radially eliminating the contact between the inner surface of the sidewall blank and the side surface of the mandrel, and by exerting an axial transfer force on the inner surface of the end member of the casing. This solution results in the advantage that the axial transfer force may be kept very moderate and fixed, since the frictional force between the inner surface of the sidewall blank and the side surface of the mandrel can be eliminated.

According to one advantageous embodiment, the contact between the inner surface of the sidewall blank and the side surface of mandrel is eliminated by focusing an outwardly radial force on the inner surface of the sidewall blank.

According to another advantageous embodiment at least one of the forces, especially the outwardly radial force, is obtained by means of a gaseous transmission medium.

According to a third advantageous embodiment the outwardly radial force is focused on the inner surface of the sidewall blank using the ducts with which the sidewall blank is wrapped around the wrapping mandrel by means of a suction effect applied by way of the said ducts.

The object of the invention is also a device for the application of the method The said device is defined in more detail in the preamble of the independent patent claim relating to the device.

What is mainly characteristic of the device is described in the characterising part of the independent patent claim relating to the device.

By using a device which corresponds to the method and applies it, equivalent advantages to those mentioned above are achieved.

In the following, the invention is described using examples with reference to the accompanying drawings, in which

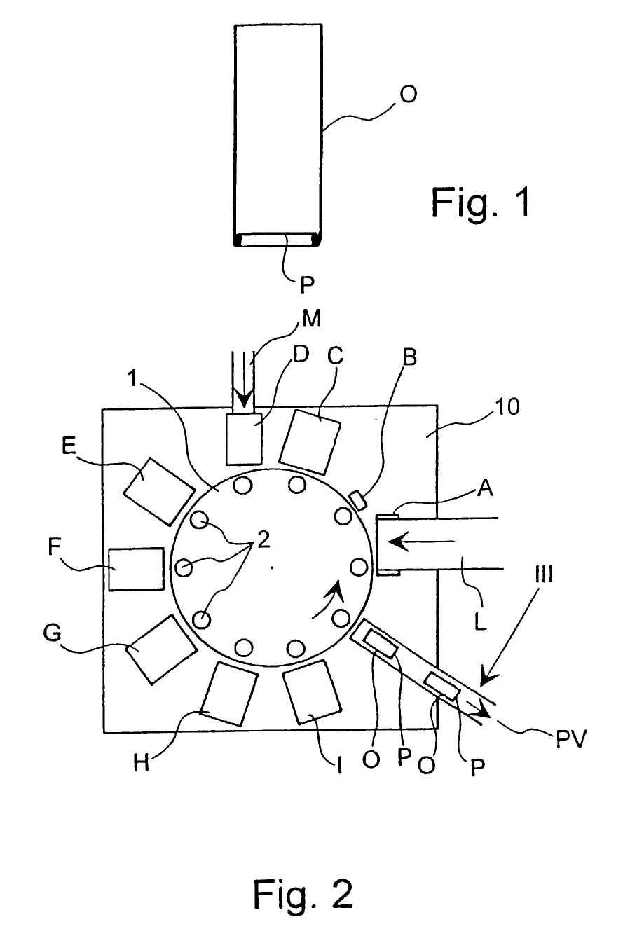

FIG. 1 shows a vertical cross-section of the casing formed in the container-forming unit,

FIG. 2 shows the container-forming unit seen from above,

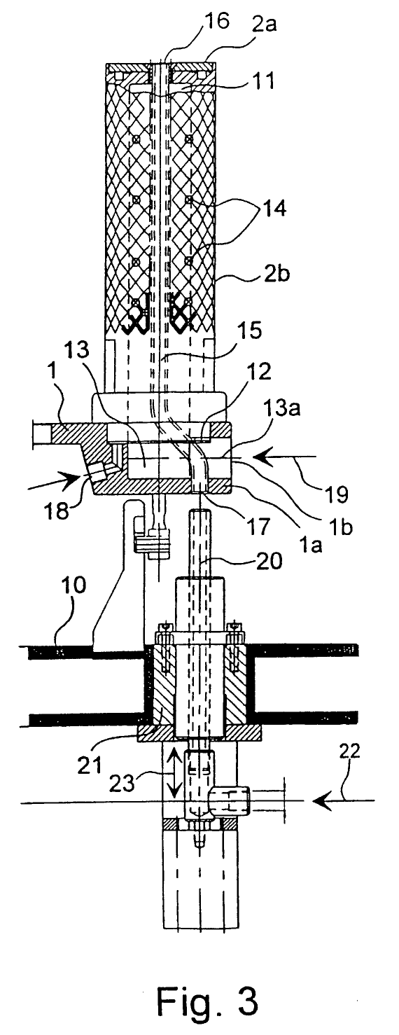

FIG. 3 is a diagrammatic view of a partial vertical section of an embodiment of a mandrel structure applying to the method relating to the invention, i.e. the wrapping mandrel structure,

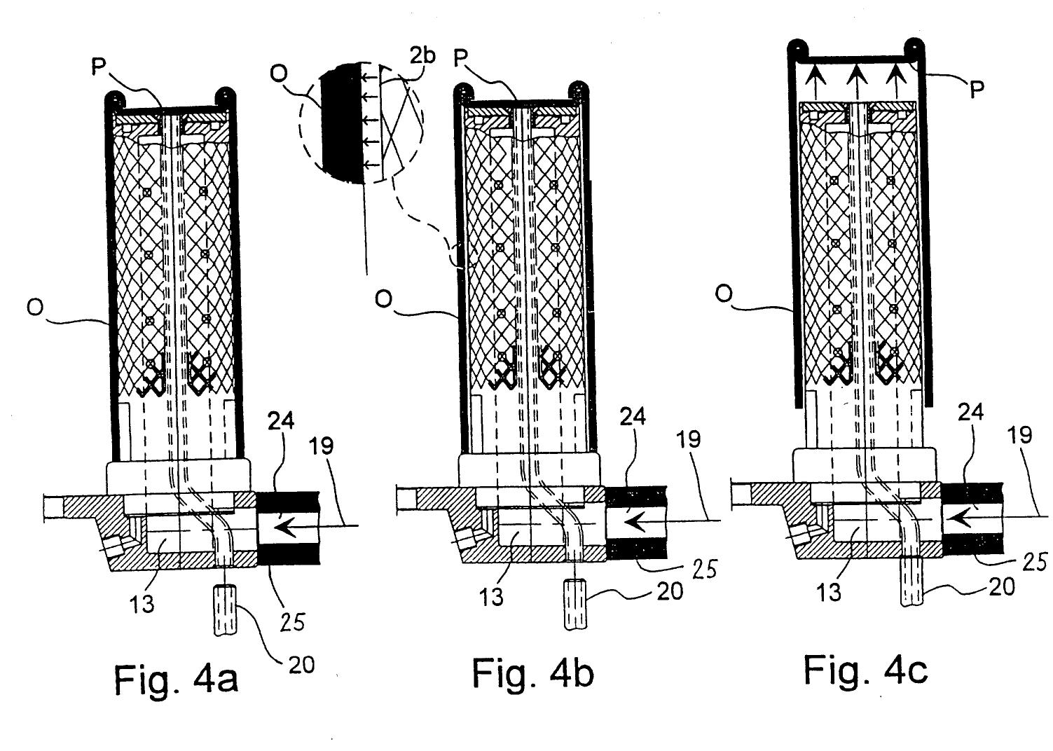

FIGS. 4a-c show in stages an embodiment of the method corresponding to the mandrel structure shown in FIG. 3, and

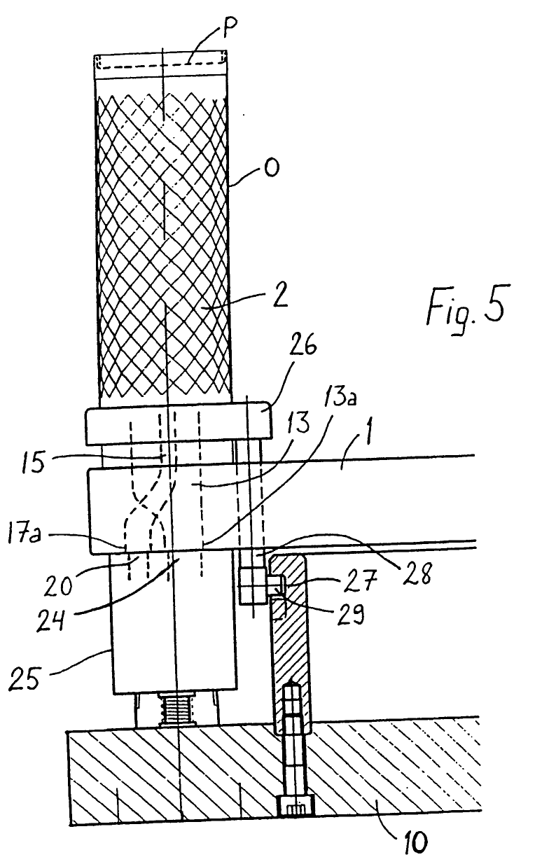

FIG. 5 shows an advantageous transmission medium connection to the mandrel structure.

Here the different parts of a liquid package will be designated as follows:

Package: a sales package or a casing according to the context

Sales package: a ready-made liquid package which is filled and closed

Casing: an unfilled and unclosed outer casing of the sales package

Can: a package which is characteristic in that it consists of a part wrapped to form a structure which is closed in the horizontal section perpendicular to the longitudinal axis, i.e. sidewall blank, one or both ends of which are closed with an end member

Container blank: a straight, planar piece, generally made out of liquid packaging board, from which a casing is formed by joining, and which can be separated from larger surface material such as an long strip

Outer surface of the blank or blank material: a surface which forms the surface visible to the outside in the ready package and which is generally provided with printing and a heat-seal coating

Inner surface of the blank or blank material: a surface which in the ready-made package forms a surface that is in contact with the contents and which generally has a heat-seal coating

Blank material: the raw material for blanks, usually liquid packaging board, coated with heat-seal coating.

The packaging machine contains a container-forming unit which forms the vertical part of the can-shaped casing in the form of a structure which is closed in its horizontal cross-section, shown in FIG. 1, i.e. sidewall blank O, to which the end member P sealing the open end of the sidewall blank O is joined. This can-shaped package, one end of which remains open is transferred to the filling unit of the packaging machine, where the final sales package is formed and which is not described in more detail here.

In the container-forming unit shown in the FIG. 2, there is a transfer table 1, which has been arranged to rotate in the horizontal plane, and on the perimeter of which there are arranged forming dies at fixed angular intervals, supporting the said container at the different forming stages. The forming dies are identical and are each formed by a vertical mandrel 2, around which the sidewall blank of the casing is formed and which hereafter is referred to as a wrapping mandrel. Apart from the transfer table 1, the container-forming unit also comprises a fixed frame in which the table has been arranged to form a rotating structure and which has been referred to generally by the reference number 10 There are as many wrapping mandrels 2 as processing stages, at each of which a certain stage of forming a can, which is open at one end, takes place. At the halt stage, when the processing stations perform certain operational stages, the wrapping mandrels are located at the processing stations, and at the advancement stage they move on by a short rotational movement of the table, which corresponds in its length to the angular distance between wrapping mandrels 2, up to the next station for the next processing stage

The different processing stations will be described in the following, mainly on the basis of their function in the forming of a can-shaped casing. All the stations have parts attached to the frame 10, which effect the desired operational stages by their movement or other action. The moving parts are situated on the frame, mainly outside the circular track of the wrapping mandrel and/or above the mandrels, or they have been situated in such a way that they are temporarily on the track of the mandrels and move out of the mandrels' way during the advancement stage FIG. 2 does not further describe these different parts, but it describes the supporting structures of the different stations to which the above mentioned functional parts have been attached.

At wrapping station A, a blank of certain height is cut off from the lower end of the blank web L transferred to the station with the help of the transfer devices situated on the frame, the said blank being pushed onto the wrapping mandrel 2 and wrapped around it in the shape determined by the outer surface of the mandrel. In this way the sidewall blank for the can-like casing is formed, the the said casing being of a closed shape in its horizontal cross-section, if the mandrels are cylindrical the shape is round.

At the sidewall sealing station B the sidewall margins of the blank which are one on top of the other at the wrapping station, are finally sealed to one another. This is done with the help of a clamping surface which presses together the overlapping margins and simultaneously cools the heat-seal coating on the inner surface of the blank, the coating having previously been heated to the bonding state.

At the preheating station C, hot air is blown into the side-sealed part towards its top end, which suitably heats the heat-seal coating on the inner surface of the blank material at this point.

At the end member station D, end members whose perimeter corresponds to the shape of the sidewall blank's horizontal cross-section, are separated by die cutting from the continuous blank web M fed to the station, after which the member is forced through the hole causing its outer edges to fold at the same time. After this the end member is pushed down into the open end of the casing using the upper end face of the wrapping mandrel as a counter surface, in such a way that the folded outer edges of the end member are pressed against the inner surface of the casing.

At the first heating station E, hot air is blown onto the outer surface of the end member, directing the air towards the edges, thus heating the part of the lower surface of the member which is at the edge folded up towards the inner surface of the upper end of the casing.

At the second heating station F the same procedure takes place in order to ensure sufficient heating around the whole upper surface.

At the clenching station G, the upper edge of the casing is turned by pressing from above the upper part of the said edge extending above the folded edge of the end member, to the centre and down, whereby it folds over the upturned outer edge of the end member.

At the first end sealing station H, the upper edge of the casing is pressed against the folded edge of the end member, whereby the heat-seal coatings heated at the previous heating stages seal the parts together, and the folded outer edge of the end member remains permanently inside the casing's upper edge, which is folded in a U-shape.

At the second end sealing station I the same operations take place as at the previous station in order to achieve an even seal at this stage around the whole can-like casing.

At the final processing station, at the discharge station J, the can-like casing is lifted from the wrapping mandrel 2 and it is transferred along the conveyor track to the filling unit of the packaging machine.

When the ready-made can has been removed from the wrapping mandrel 2 the mandrel moves again with a short rotational movement of the table 1 to the wrapping station A to receive a new sidewall blank, and the above mentioned processing stages are repeated.

Typical processing times in each station A-J may be approximately 500 ms which includes the transfer from one station to another. Thus a can may be made ready in container-forming unit in approximately 5 seconds, and the production capacity is 1 can/0.5 s, i.e. approx. 120/min.

The wrapping mandrel 2, further described in FIG. 3, is attached in an upright position on the upper surface of the transfer table 1. Inside the wrapping mandrel 2 there is a hollow 11, that is open from below and closed from above (at the end face of the wrapping mandrel 2). The open lower end 12 of the hollow 11 has been joined to chamber 13 at the edge of the transfer table 1 at the wrapping mandrel 2, the chamber 13 having an open connector 13a to join the chamber 13 to the pressure medium connection. In the described application the vertical inner surface of the hollow 11 and the surface of the outer surface 2b of the wrapping mandrel 2 have been joined by a series of holes 14 that have been situated at fixed distances on the circumference of the wrapping mandrel 2 in both radial and axial direction.

Furthermore, in the hollow 11 of the wrapping mandrel 2 has been arranged centrally in the horizontal cross section, a tube 15 in an axial direction or a similar passage, the upper, open end 16 of which is on the level and in the middle of the end face 2a of the wrapping mandrel 2. The hollow 11 is thus an elongated annular space. The tube 15 has been joined via the chamber 13 to the lower surface of the transfer table 1 where its lower, open end 17 opens In the edge of the transfer table 1, especially on its extension 1a, into which also the chamber 13 has been formed, has also been formed a connector 18 which is in connection with the cooling ducts formed between the hollow 11 of the wrapping mandrel 2 and the outer surface 2b of the wrapping mandrel 2 (ducts not described).

The above described arrangement works as follows when applied to the method After the casing in the forming unit has moved forward to the discharge station J the release in radial direction of the contact between the inner surface of the sidewall blank of the casing and the outer surface 2b of the wrapping mandrel 2 is effected at the first stage. This is achieved by feeding a gaseous pressure medium, preferably air, to the chamber 13 in the direction of the arrow 19, which releases the contact between the inner surface of the sidewall blank and the outer surface of the wrapping mandrel, and possible frictional contacts between the said surfaces are lost. The blowing from the direction of the arrow 19 is realised e.g. with the help of a pressure medium coupler joined to the edge 1b of the transfer table 1 in the discharge station J (not described in FIG. 3), after which the pressure medium coupler is connected to the chamber 13.

After these stages vertical removal of a tube-like connector 20 takes place in order to achieve contact with the lower end 17 of the tube 15, and blowing (arrow 22) via the tube 15 into the hole 16 takes place, whereby the casing OP is removed from the wrapping mandrel 2 due to the force directed in the axial direction to the bottom P of the casing.

As seen in FIG. 3, connector 20 has been fitted with a sliding adapter into a vertical sleeve structure 21 attached to a fixed frame 10, which allows the connector to be moved into contact with the lower end 17 of the tube 15 (arrow 23) forming a seal. Transfer energy is transmitted from the lower end of the connector pipe. The lower end 17 of the tube 15 is outwards bevelled and similarly the upper end of the tube 20 is inwards bevelled, which results in a conical joint, which is sufficiently sealed because of both the design of the surfaces and the compressive force achieved.

Impulses, i.e. blasts, that are exerted on the inner surfaces of the casing OP, brought from the mandrel 2 with the help of a gaseous pressure medium, are realised e.g. by means of solenoid valves (not described), that have been arranged to work in stages in such a way that the blast transmitted via holes 14, i.e. the release of the contact between the outer surface 2b of the wrapping mandrel 2 and the inner surface of the sidewall blank of the casing OP, is effected at the first stage and only after that does the discharge via the tube 15 takes place. The vaihesiirto of these blasts is approximately 10 ms. It is advantageous to maintain the blast via the holes 14 for at least some time simultaneously with the exhaust. After the casing OP has been removed from the wrapping mandrel 2 the blowing stops. Contacts between the chamber 13 and the pressure medium coupler, and between connector 20 and the lower end 17 of the tube 15 are released, after which the wrapping mandrel 2 is ready for the next stage A (FIG. 2).

FIGS. 4a-c describes in stages the above mentioned process of releasing a casing. The figure shows with a reference number 24 the feeding hole to the chamber 13. The hole 24 may e.g. be situated in the arc-shaped sliding member 25 in constant contact with the edge of the round table 1, and the sliding member 25 contacts with the chamber 13 as the mandrel 2 moves forward to the discharge station J.

Parts that are referred to with numbers 15, 16, 17; 20 and 21 in FIG. 3 thus form the members by means of which axial transfer energy directed onto the inner surface of the end member of the casing OP is generated. Correspondingly, the parts that are referred to with numbers 13, 11, 14 and 21 in FIGS. 3 and 4 form the members by means of which the release of contact between the outer surface 2b of the wrapping mandrel 2 and the inner surface of the sidewall blank O of the casing OP is effected.

FIG. 5 shows a version adapted from the version applying to FIG. 3, which is advantageous in that it has few moving parts and has a simple structure. The filling connectors for a pressure medium, preferably air, are pressure member couplers, so-called sliding members, that are, seen from the mandrel 2 from opposite side, in constant contact with feeding table 1, and their surface equipped with a blowing hole is sealed against the surface of a feeding table equipped with a similar hole, but allows the table to slide with sufficiently low friction. Both filling connectors have been situated in the side of the lower surface of the transfer table 1, which has a sufficiently large surface for the sliding members. The hole opening against the table 1 forms a filling connector 20 to exert the gaseous medium in axial direction and the other hole forms a filling connector 24 to exert force in radial direction. The holes may be situated side by side in the same sliding member 25 in such a way that they meet the end 17a of the tube and the connector 13a of the chamber opening to the surface of the table after the mandrel 2 has reached the discharge station. Pressurised air can be connected to both holes in a known manner and sequence of operations can be controlled in the above described manner. The advantage of this solution is that there are only few, mechanical motions. At least on the surface of the table the material of the sliding member 25 can be plastic, which creates little friction with the material of the surface of the table, usually metal.

It is also possible that one of the feeding connectors is in its own sliding member against the outer edge of the table 1, in a way described in FIG. 3, and the other connector is in the sliding member against the lower surface of table. In order to save space and with regard to installation tolerances, the best solution is to situate the feeding connectors in the same sliding member 25 against the lower surface of the table 1.

FIG. 5 furthermore shows the elevating member 26 situated in the base of the mandrel 2 arranged to move back and forth in the longitudinal axis of the mandrel The elevating member 26 is force-controlled with the help of the control track 27 parallel with the conveyor track of the mandrel situated on the frame of the container-forming unit onto the opposite side of the level of the table 1. The elevating member that advantageously is a member surrounding the mandrel in an annular manner is in connection to the control track 27 by means of an arm 28 passed through table 1 and a control cam 29 that is situated on the arm and touches the track 27. The elevating member 26 is able to lift the sidewall blank up on the mandrel if needed, in the places determined by the track 27, and in the discharge station a can be lifted with it a few millimetres before the release operations.

Especially the chamber 13 and holes 14 can be used during the wrapping of the sidewall blank O of the casing OP in order to create a suction effect exerted on the sidewall blank O. Furthermore, the open, upper end 16 of the tube 15 or the like can be formed to consist of several parts by branching the upper end of the tube 15, whereby a pressurised air impulse can be spread more widely on the end face 2a. Even though the term “wrapping mandrel” has been used in the explanation, the sidewall blank O can be also situated on the mandrel as a ready-made, cylindrical tube, in which case the mandrel would be primarily used for the removal of the sidewall blank and as an aid in attaching the end member.

It is obviously possible to give a can such a strong starting impulse in the axial direction that the can may be moved in this direction completely outside the mandrel. After the removal from the mandrel the can may be advanced to the filling unit with a suitable conveyor e.g. with a tube, that follows the mandrel in the axial direction in the discharge station, and gaseous transmission medium e.g. air is conducted to the tube in order to advance the cans further.

1. A method in a packaging machine in the container-forming unit of which the casing is formed so as to be substantially ready in the container-forming unit, when the sidewall blank (O) of the casing is situated on at least one mandrel or the like, preferably on the side surface (2a) of a wrapping mandrel, and the first end member (P) of the casing is placed on the face of the mandrel and this end member is joined to the end of the sidewall blank, after which the casing which was formed on the mandrel is removed from it to be taken on to the next process stage to be carried out in the package machine by directing an axial transfer effect towards the inner surface of the end member (P) of the casing (OP), characterised in that the removal of the casing (OP) from the mandrel 2 in such a way that the contact between the inner surface of the sidewall blank (O) and the outer surface (2a) of the mandrel is released in the radial direction, and axial transfer energy is directed towards the inner surface of the end member of the casing (OP).

2. A method applying to the claim 1, characterised in that the contact between the inner surface of the sidewall blank of the casing and the side surface of the mandrel (2) is released by directing a radial outwardly directed force towards the inner surface of the sidewall blank (O).

3. A method applying to a claim 1 or 2, characterised in that at least one of the forces—radial outwardly directed force or axial transfer energy—is a gaseous pressure medium, preferably air.

4. A method applying to one of the claims 1-3, characterised in that at the first stage the contact between the inner surface of the sidewall blank (O) and the outer surface (2a) of the mandrel (2) is released, and once the contact is substantially released, at the second stage an axial transfer energy is directed towards the inner surface of the end member of the casing (OP).

5. A method applying to the claim 3 or 4, characterised in that a gaseous transmission medium, in order to create at least one of the forces, is brought through a structure supporting the mandrel (2) and moving from a station to station from the opposite side of the structure, for example from the opposite side of the surface of the transfer table (1) through the table.

6. A device in a packaging machine, in the container-forming unit of which the casing is formed to make it substantially ready, whereby the sidewall blank (O) of the casing is situated at least on one mandrel or the like, preferably on the outer surface (2a) of a wrapping mandrel in the container-forming unit, and the first end member (P) of the casing is placed on the end face of the mandrel, and the end member is joined to the bottom portion of the sidewall blank, whereby the casing formed on the mandrel is removed from the mandrel to be advanced to the next process stage carried out in the packaging machine, in which case the device comprises the members (15, 16, 17; 20, 21) in order to remove the casing (OP) from the mandrel (2) with axial transfer energy directed towards the inner surface of the end member (P) of the casing, characterised in that the device furthermore includes the members (13, 11, 14, 24) in order to release in the radial direction the contact between the inner surface of the sidewall blank (O) and the outer surface (2a) of the mandrel (2), especially during the duration of action of a substantially axially directed transfer energy generated by the members (15, 16, 17; 20, 21).

7. A device applying to the patent claim 6, characterised in that both members (15, 16, 17; 20, 21; 13, 11, 14, 24)—working in both radial and axial direction—have been arranged to work be means of a gaseous pressure medium in order to generate transfer energy.

8. A device applying to the patent claims 6 or 7, characterised in that inside the mandrel (2) a hollow (11) has been formed and at least some of the members (15, 16, 17; 20, 21; 13, 11, 14, 24) that work in both axial and radial direction have been situated in the hollow (11).

9. A device applying to the patent claims 6 or 8, characterised in that in order to generate axial transfer energy the members (15, 16, 17, 20, 21) comprise:
a tube (15) or a similar passage passing through the mandrel (2), the upper open end (16) of the tube (15) being situated on the end face (2a) of the mandrel, and the lower open end (17) of which is situated in connection with the transfer table (1), whereby the lower open end (17) is, at least during the action of the axial transmission energy, in connection with the members (20, 21) in order to feed a gaseous pressure medium to the tube (15) and via its end (16) to the inner surface of the end member (P) of the casing (OP).

10. A device applying to one of the patent claims 6-9, characterised in that the members (13, 11, 14) in order to create the transfer energy for releasing the radial contact between the parts (O and 2b) comprise: a chamber (13) with a connector (13a) in connection with the hollow (11) of the mandrel (2), and holes (14) formed between the surface of the hollow (11) and the outer surface (2b) of the mandrel (2), the holes being situated on the outer surface (2b) of the mandrel (2) both in the direction of its circumference and in axial direction, when the connector (13a) is, at least during the action of radial transfer energy, in connection with the members (24) in order to feed the gaseous pressure medium, and thus in order to release the contact between the parts (O and 2b), through the chamber (13) to the hollow (11) and on via the holes (14) to the outer surface (2b) of the mandrel (2).

11. A device applying to the patent claims 9 and 10, characterised in that the tube (15) or a similar passage has been arranged around the central axis of the hollow (11), whereby the hollow (11) is substantially in the form of an annular space equivalent to the length of the mandrel (2).

12. A device applying to one of the patent claims 6-11, characterised in that the feeding connector in order to conveying the pressure medium generated at least one of the forces has been situated in a sliding member (25), that is against a structure supporting and moving the mandrel (2), for example the moving structure of the transfer table (1), advantageously against the surface that is on the opposite side of the structure in relation to the mandrel (2).

13. A device applying to the patent claim 12, characterised in that the feeding connector (20) for a pressure medium generating force in axial direction and the feeding connector (24) for a pressure medium generating force in radial direction have been situated in the sliding member against a structure supporting and moving the mandrel (2), for example the moving surface of the transfer table (1).

14. A device applying to the patent claim 13, characterised in that both of the feeding connectors (20, 24) have been situated in the same sliding member (25) that is advantageously against the surface on the opposite side of the structure in relation to the mandrel (2).
